(19) United States
(12) Patent Application Publication
(10) Pub. No.: US 2015/0268817 A1
(43) Pub. Date: Sep. 24, 2015

(54) ONLINE SYSTEM, METHOD AND COMPUTER PROGRAM PRODUCT FOR EVENT PLANNING

(71) Applicant: Suitcase L.L.C., Ann Arbor, MI (US)

(72) Inventors: Hoang Te Phan, Ann Arbor, MI (US); Minh Quan Phan, Ypsilanti, MI (US); Mingrui Jiang, Ann Arbor, MI (US)

(73) Assignee: Suitcase LLC

(21) Appl. No.: 14/661,875

(22) Filed: Mar. 18, 2015

Related U.S. Application Data
(60) Provisional application No. 61/955,549, filed on Mar. 19, 2014.

(51) Int. Cl. G06F 3/0481; G06F 3/0482; G06F 3/0484

(52) U.S. Cl. CPC G06F 3/04817; G06F 3/04847; G06F 3/04842; G06F 3/0482

(57) ABSTRACT

An event planning system, using both computer system software and hardware, that has a user-friendly, interactive, three-dimensional planning space for a user that can be updated with real-time, accurate vender information to aid in event planning. Such vendor information is received, stored, updated, categorized, re-categorized and matched with selectable user parameter as necessary to allow users to customize their virtual planning space or first focal space. Once users customize a focal space, they can act in their space to perform three-dimensional modeling of the first focal space, including making snapshots and short movies to visualize their event.

### CROSS-REFERENCE TO RELATED APPLICATIONS

This application claims priority to U.S. Provisional Patent Application Ser. No. 61/955,549, filed Mar. 19, 2014, entitled “ONLINE SYSTEM, METHOD AND COMPUTER PROGRAM PRODUCT FOR EVENT PLANNING.” All of the foregoing application is hereby incorporated by reference.

### BACKGROUND

1. Field of the Invention

The present invention relates to event planning. More particularly, the present invention relates to operations encoded on a machine-accessible medium, a method to operate a graphical user interface, and a system for event planning.

2. Background

Event planning for major events can be a time consuming, expensive, and daunting process. Major events, such as weddings, graduations, company events, and other large gatherings, often involve multiple, detailed choices and can result in hiring additional event planning help. Often times, event planners need to know and make an emotional investment in the specifics of each choice as it is made. Such choices include the event date, venue, venue seating, guest list, food, drinks, and so on. Further, budgets and prices dictate which vendors can provide what products to meet the event planner's needs. In addition, one choice may dictate another choice.

With so many decisions to make, the time commitments and locations of each vendor make it difficult for an event planner to see an actual venue or product on-site, especially at multiple times throughout the event planning process. This can be further complicated when multiple event planners are involved.

Likewise, if the event planner is a bride and the wedding is taking place remotely, such as in another state, it is especially difficult for the bride to see how the reception venue will look.

### BRIEF SUMMARY OF THE INVENTION

The invention may include any of the following aspects in various combinations and may also include any other aspect described below in the written description or in the attached drawings. In a first aspect, the event planning system may be operations encoded on a machine-accessible medium. In this aspect, an article of manufacture may have a first device and the machine-accessible medium, the machine-accessible medium having instructions encoded thereon for enabling a user to use a machine to perform the following operations.

First, the instructions may provide for displaying a first focal space on the first device, the first device having a first storage and a first display, the first display displaying the first focal space. A “focal space” is a virtual reproduction of an event venue to assist in event planning (e.g. reception room or any further indoor/outdoor space for an event). The focal space may be a plurality of focal spaces. The first focal space may be three-dimensional and customizable, the first focal space including a first set of selectable user parameters. The first set of selectable user parameters may be stored in the first storage or a remote storage. The first focal space may be a plurality of first focal spaces for event planning.

Second, the instructions may provide for receiving at least one user entry indicative of the user selecting from the first set of selectable user parameters, the at least one user entry defining a first selected user parameter. The step of receiving at least one user entry may include the first display being a touchscreen having a plurality of first buttons, the first selected user parameter being received by way of one of the plurality of first button.

Third, the instructions may provide for communicating with a second device having a second storage, the second storage comprising a user storage for saving the first focal space and a vendor information storage containing vendor information, the second storage being remotely stored from the first storage.

The step of communicating with a second device may include updating the vendor information with a plurality of vendor inputs, the plurality of vendor inputs being real-time. Additionally, the step of communicating with a second device comprises the vendor information being selected from a group of a minimum room, a cost, availability, a product, a color, a name, an address, a phone number, a website, and advertising.

Fourth, the instructions may provide for retrieving a subset of the vendor information corresponding to the first selected user parameter. Fifth, the instructions may provide for updating the first focal space on the first display with the subset of the vendor information corresponding to the first selected user parameter. Through these instructions and operations, the article of manufacture assists in event planning.

The instructions or operations may further include interacting with the first focal space after the step of updating the first focal space, wherein interacting with the first focal space comprises a step selected from a group of expanding the first focal space, reducing the first focal space, displaying a short movie of the first focal space, displaying a snapshot of the first focal space, and displaying an overhead view of the first focal space. Displaying an overhead view may include the first display switching from a three-dimensional view of the first focal space to a two-dimensional view of the first focal space wherein the two-dimensional view displays the entire first focal space on the first display.

The operations may further include displaying a vendor list or a cost summary based on the subset of the vendor information after the step of updating the first focal space. The cost summary may include receiving a plurality of user entries indicative of the user selecting from the first set of selectable user parameters wherein the cost summary is based on the plurality of user entries.

As one advantage, these instructions may provide a user-friendly, interactive, three-dimensional planning space for a user that can be updated with real-time, accurate vender information to aid in event planning. This system may simplify the difficult process of event planning, particularly if the user will have difficulty visiting and customizing the actual venue on-site. While this space is virtual, displayed through a computer system, it is designed to be as realistic as possible, without visiting the actual space on-site, such as the venue or reception room. The focal space is a virtual, interactive, real-time, three-dimensional space modeled after the user's chosen venue.

The focal space is customizable based on user input or entries. The system provides selectable user parameters, or possible user entries. The system displays a variety of selectable user parameters in the focal space. Once a user makes a choice, the system may receive and store this information as a selected user parameter. For example, the event planner may select parameters such as venue, theme, products, colors, date, budget, and prices.

The system also may receive and store vendor information. Such vendor information includes venue, real-time price list, real-time availability, products, colors, pictures, name, address, email, phone number, website, and advertising. In one embodiment, a vendor can sign up for the system and input information or a system administrator may do this.

In another aspect, the event planning system may be a method of using a graphical user interface by a user, the graphical user interface being a component in a computer system, the computer system having a display and a user interface selection device. The method may include providing a first focal space having a first, a second, and a third menu. The first focal space may be displayed on the display. The first menu may be a first column of selectable user parameters, the second menu may be a second column of selectable user parameters, and the third menu may be a row of selectable user parameters. The first, second and third menus may define a plurality of possible user entries.

In this aspect, the first display may have a left side, a right side, and a bottom, the first menu being disposed on the left side, the second menu being disposed on the right side, and the third menu being disposed on the bottom. The first, second, and third menus may outline the first focal space.

The method may further include receiving at least one user entry indicative of the user interface selection device selecting one user parameter of one of the first column, second column, and row of selectable user parameters. The step of receiving at least one user entry may include receiving the at least one user entry from the row of selectable user parameters.

In response to the at least one user entry, the method may include updating the other two of the first column, second column, and row to display a plurality of user parameters associated with the at least one user entry. In this way, the graphical user interface assists in event planning. The step of updating the other two of the first column, second column, and row may include updating the first and second columns of selectable user parameters. In addition, the step of updating may involve updating all of the first column, second column, and row.

In a particular configuration, the step of updating the other two of the first column, second column, and row may include the third menu being a genus of selectable user parameters, the first menu being a species of selectable user parameters, and the second menu being a subspecies of selectable user parameters wherein the computer system may receive the at least one user entry from the genus of selectable user parameters and, in response, may update the species and subspecies of selectable user parameters, defining a menu hierarchy.

In another aspect, the system for event planning may comprise a first device, a second device, and a third device. In this way, multiple devices may access saved focal spaces. For example, the first device may have a first storage and a first display, the first display displaying a first focal space as described above. The first focal space may include a first set of selectable user parameters, the first device being adapted to receive a first user entry indicative of the user selecting from the first set of selectable user parameters, the first user entry defining a first selected user parameter.

The second device may have a second storage. The second storage may have a user storage for saving the first focal space and a vendor information storage containing vendor information. The second storage may be remotely stored from the first storage. The second device may be adapted to retrieve a subset of the vendor information corresponding to the first selected user parameter. The second device may also be adapted to send the subset of the vendor information to the first device wherein the first device updates the first display with the subset of the vendor information.

The third device may have a third display wherein the third device may access the saved first focal space comprising the first selected user parameters from the user storage. The third device may display the first selected user parameter on the third display. The third device may be adapted to receive a second user entry on the third display, the second user entry defining a third selected user parameter. The second device may be adapted to save the third selected user parameter in the user storage.

Once the user customizes the focal space, the user can act in a customized focal space to create snapshots or short movies to share with others and aid in event planning. The user can also save, modify, and bookmark a customized focal space and create multiple focal spaces, each with all the functions described herein. In addition, once the user customizes the focal space, the system updates the aforementioned vender information in the vendor list. From this list, the user can select a particular vendor for a particular user parameter.

The system can be modified to include locked and unlocked selectable user parameters. For example, unlocked parameters are available to all users who have the system. However, locked parameters are not initially available to users until they pay for an upgrade to the system, unlocked some or all of the previously locked parameters.

As one possible advantage of the above described aspects, the system may allow for a first device, with a lower amount of first storage compared to the second storage on the second device, to run the features of the system by pulling up solely what features the user presently uses. Any additional features can be accessed from the second storage at a later time. Because the system's vendor information storage and user storage may be in the second device, the first storage may be smaller as compared to the second storage. As a result, the first device may be a smart phone or tablet device.

The present disclosure may be better understood by referencing the accompanying figures.

### BRIEF DESCRIPTION OF THE DRAWINGS

FIGS. 1A-B are flowcharts of methods of use for an event planning system in accordance with embodiments of the present invention;

FIG. 2 is a block diagram of the system of FIG. 1;

FIGS. 3A-B are screenshots illustrating a first focal space of the system of FIG. 1;

FIGS. 4A-C are screenshots illustrating a customized first focal space of the system of FIG. 1;

FIGS. 5A-F are screenshots illustrating vendor information in accordance with the system of FIG. 1;

FIGS. 6A-D are screenshots illustrating a featured venue in accordance with the system of FIG. 1;

FIG. 7 is a screenshot illustrating a snapshot view in accordance with the system of FIG. 1;

FIGS. 8A-B are screenshots illustrating first views of a movie in accordance with the system of FIG. 1;

FIG. 9 is a screenshot illustrating a second view of a movie in accordance with the system of FIG. 1;

FIG. 10 is block diagram of the system of FIG. 1;

FIG. 11 is a screenshot illustrating a bookmark gallery in accordance with the system of FIG. 1; and

FIG. 12 is a screenshot illustrating an upgrade screen in accordance with the system of FIG. 1.

### DETAILED DESCRIPTION

The present disclosure will now be described more fully with reference to the accompanying figures, which show preferred embodiments. The accompanying figures are provided for general understanding of the structure of various embodiments. However, this disclosure may be embodied in many different forms. These figures should not be construed as limiting.

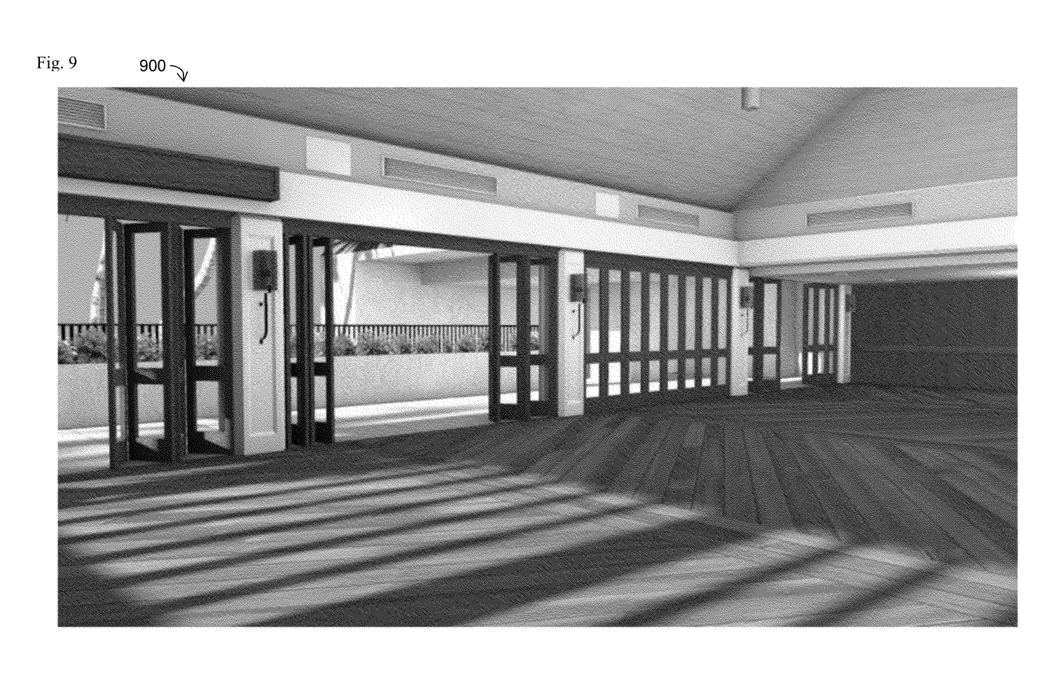

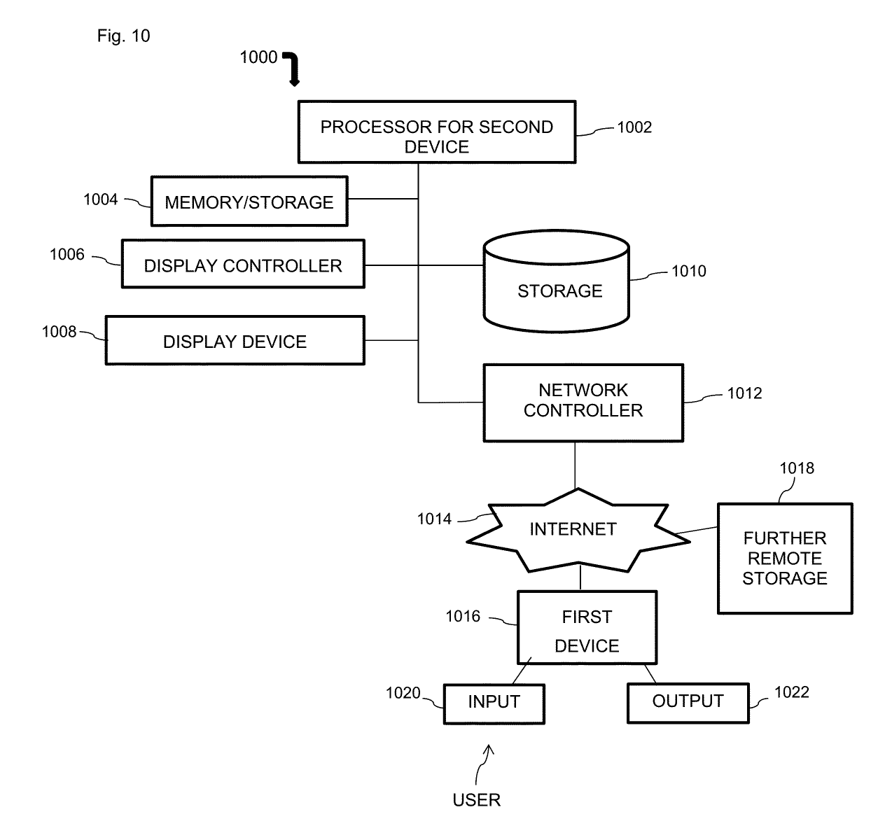

In a preferred embodiment, an event planning system is provided and used for wedding planning. Notably, the system allows a user to plan and visualize a wedding reception. The user in this case can be a bride, a groom, other user, an event planner, or an event vendor. However, it should be understood that the disclosed system can be used to plan other types of events such as birthday parties, graduations, corporate events, sporting events, receptions and the like. The event planning system is generally a software program that operates on hardware such as a computer (see e.g., FIG. 10), including hand held computers, smart phones, tablets and the like.

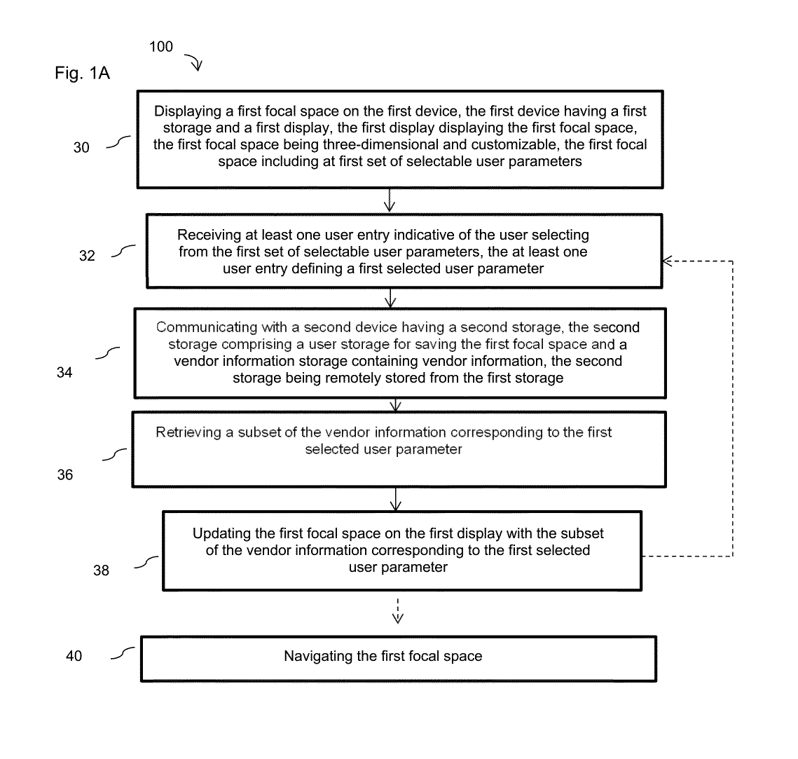

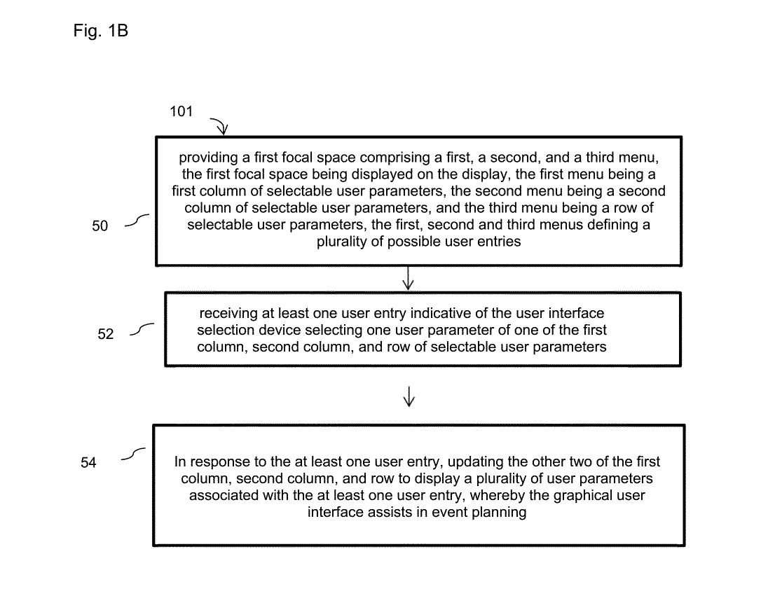

Referring to FIG. 1A, a flowchart 100 depicts one aspect of the method of using, and the steps performed by, an event planning system according to the present disclosure. In step 30, the operations direct that the event planning system displays a first focal space on the first device, the first device having a first storage and a first display, the first display displaying the first focal space, the first focal space being three-dimensional and customizable, the first focal space including a first set of selectable user parameters.

The focal space is a virtual, interactive, three-dimensional environment to aid in event planning. In a preferred embodiment, this focal space is a room, such as a reception room for a wedding reception. Further, in a preferred embodiment is the user may select the first focal space to be a minimum room, which contains minimal event planning information until the user selects user parameters. Upon selecting user parameters, the minimum room becomes a customized focal space or customized room. Preferably, the focal space is a three dimensional software recreation of real-world locations, such as buildings or outdoor landscapes.

As will be apparent, the system offers a plethora of selectable user parameters or options for the user to choose when customizing a focal space. The system categorizes and re-categorizes these user parameters as it receives user entries in many different ways to facilitate event planning. On the first device with a first display, this first set of selectable user parameters include a minimum room, theme, products, colors, date, budget, and prices, as will be described in further detail herein below. It will be recognized by the skilled artisan that this first set of selectable user parameters are exemplary and a user may select other types of event information without going beyond the scope and purpose of the disclosure.

In step 32, the system receives at least one user entry indicative of the user selecting from the first set of selectable user parameters, the at least one user entry defining a first selected user parameter. Now, at least one user parameter has been selected.

In step 34, the event planning system communicates with a second device having a second storage, the second storage comprising a user storage for saving the first focal space and a vendor information storage containing vendor information, the second storage being remotely stored from the first storage.

In step 36, the system retrieves a subset of the vendor information corresponding to the first selected user parameter. In step 38, the event planning system updates the first focal space on the first display with the subset of the vendor information corresponding to the first selected user parameter. Such stored vendor information includes venue, real-time price list, real-time availability, products, colors, pictures, name, address, email, phone number, website, and advertising. This information will also be discussed in more detail herein below, and the skilled artisan will likewise recognize that other information may be used by the system The vendor information is based on a plurality of vendor inputs. The system may cycle through steps 32 to 38 until the first focal space is customized to the user's satisfaction.

In optional step 40 (depicted with a dashed line), the system allows for interaction with or navigation of the first focal space by the user. The first display may be a touchscreen having a plurality of first buttons. The user may use the plurality of first buttons to input first selected user parameters. In addition, interacting with the first focal space may include actions such as expanding the first focal space, reducing the first focal space, displaying a short movie of the first focal space, displaying a snapshot of the first focal space, and displaying an overhead view of the first focal space.

FIG. 1B depicts an additional method 101 of using the system, specifically a method of using a graphical user interface by the user. In this aspect, the computer system has a display and a user interface selection device. First in step 50, the system provides a first focal space comprising a first, a second, and a third menu, the first focal space being displayed on the display, the first menu being a first column of selectable user parameters, the second menu being a second column of selectable user parameters, and the third menu being a row of selectable user parameters, the first, second and third menus defining a plurality of possible user entries.

Second in step 52, the system may receive at least one user entry indicative of the user interface selection device selecting one user parameter of one of the first column, second column, and row of selectable user parameters. Third in step 54, in response to the at least one user entry, the system may update the other two of the first column, second column, and row to display a plurality of user parameters associated with the at least one user entry, whereby the graphical user interface assists in event planning. Both of the methods in FIGS. 1A-B will be illuminated further below.

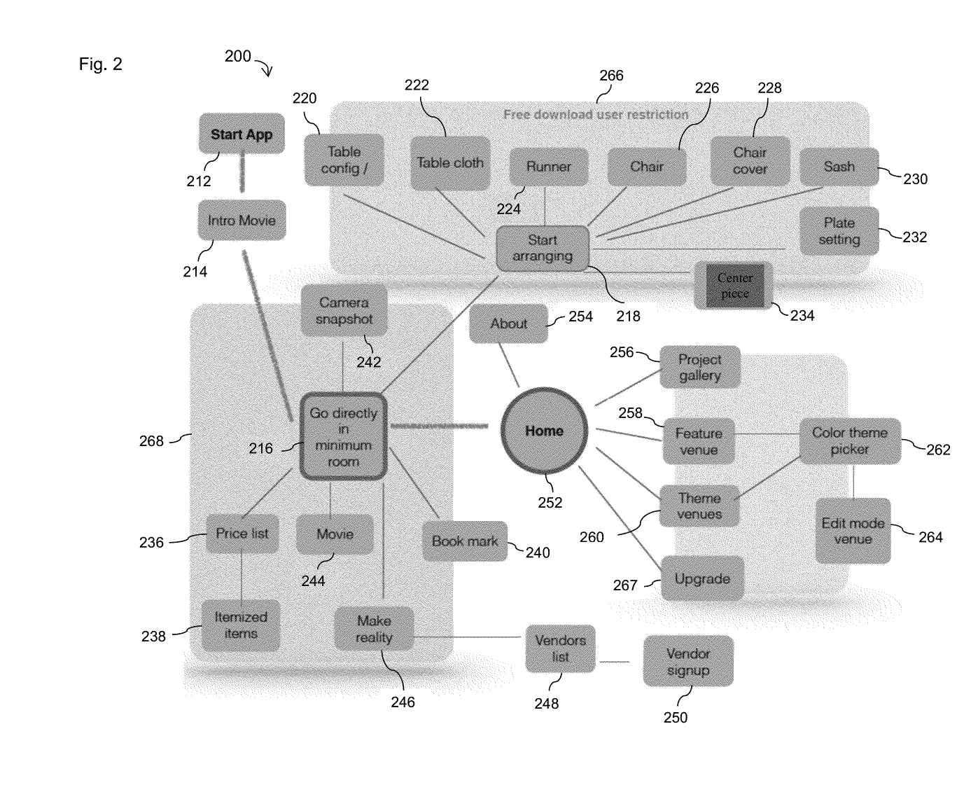

FIG. 2 provides a more in-depth, block diagram of a preferred system 200. In this embodiment, the user starts the event planning system at the start app block 212. The system brings the user to an introduction movie 214, and is optional. Upon exiting introduction movie 214, the system brings the user to a focal space. In a preferred embodiment the focal space is minimum room 216. Minimum room 216 is three-dimensional and interactive, allowing the user to select user parameters. In a preferred embodiment the minimum room 216 is displayed on a touch-based user display. Further, in a preferred embodiment, the touch-based user display, or touchscreen, has a view and buttons. The system can readily be employed with non-touch screen devices and operated with a variety of input devices.

Using the user display (or other input device), the user can perform actions such as tapping buttons to select user parameters, pinching the touchscreen view to reduce or expand the scope of the user display (e.g. zoom-in and zoom-out). The user can also swipe to spin the user display or tap to stop spinning the user display. These user actions occur in, and because of, the three-dimensional focal space. It should be understood that the user can perform other actions that accomplish these same reactions in the event planning system, such as by providing additional buttons on the touch screen or via other input devices, such as a mouse or keyboard. Further, the system acts in real-time such that any vendor information displayed on the user display is updated and current.

In minimum room 216 the user can select a plurality of user parameters. First, the user can navigate to the start arrangement block 218, e.g. by tapping on a button or particular location on the screen such as one of the tables provided in the minimum room 216. Once the user starts arranging using the event planning system, they can select parameters such as table configuration 220, tablecloth 222, runner 224, chair 226, chair cover 228, sash 230, plate setting 232, and center piece 234. While a table setting has been depicted herein, other focal spaces for an event could also be utilized for the arrangement block 218, such as a stage, a podium, a backdrop or the like.

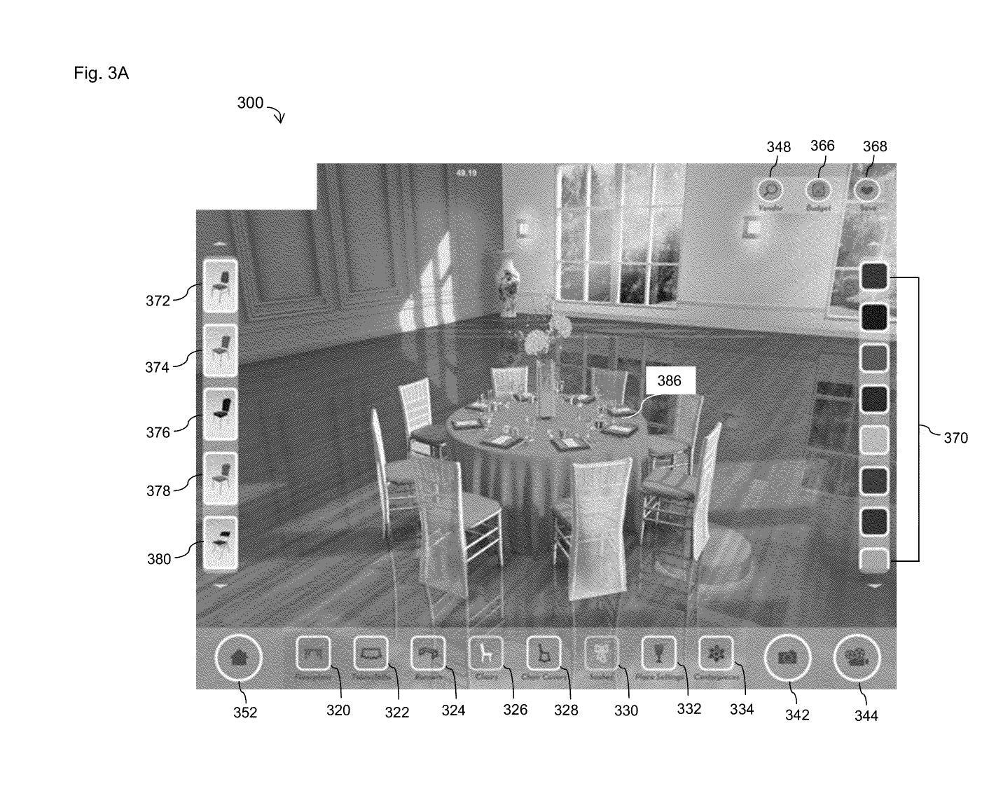

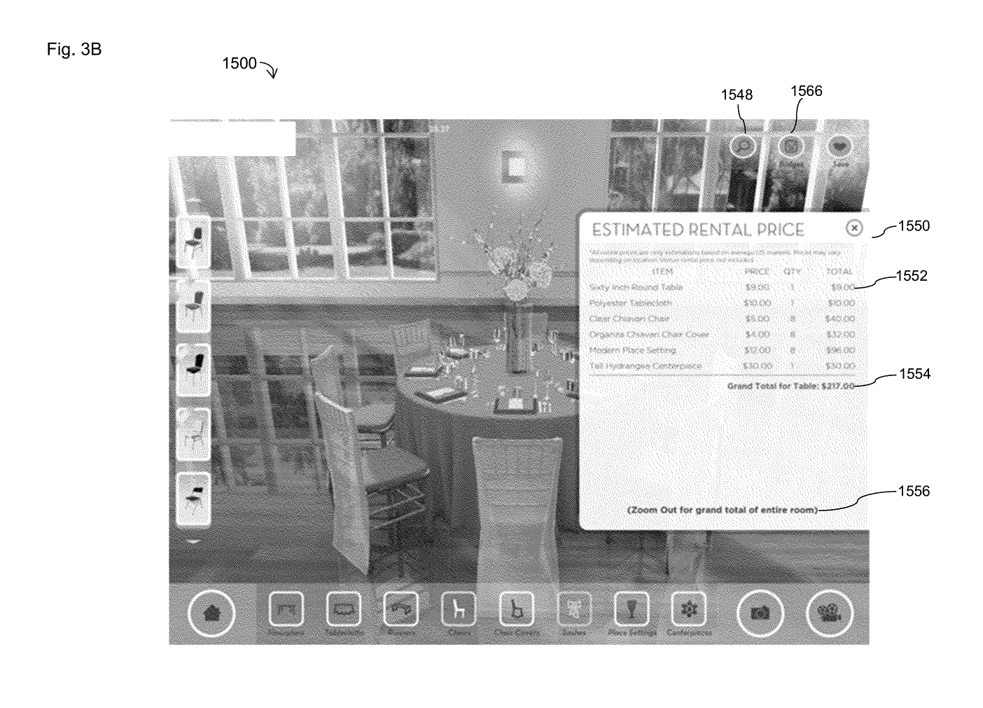

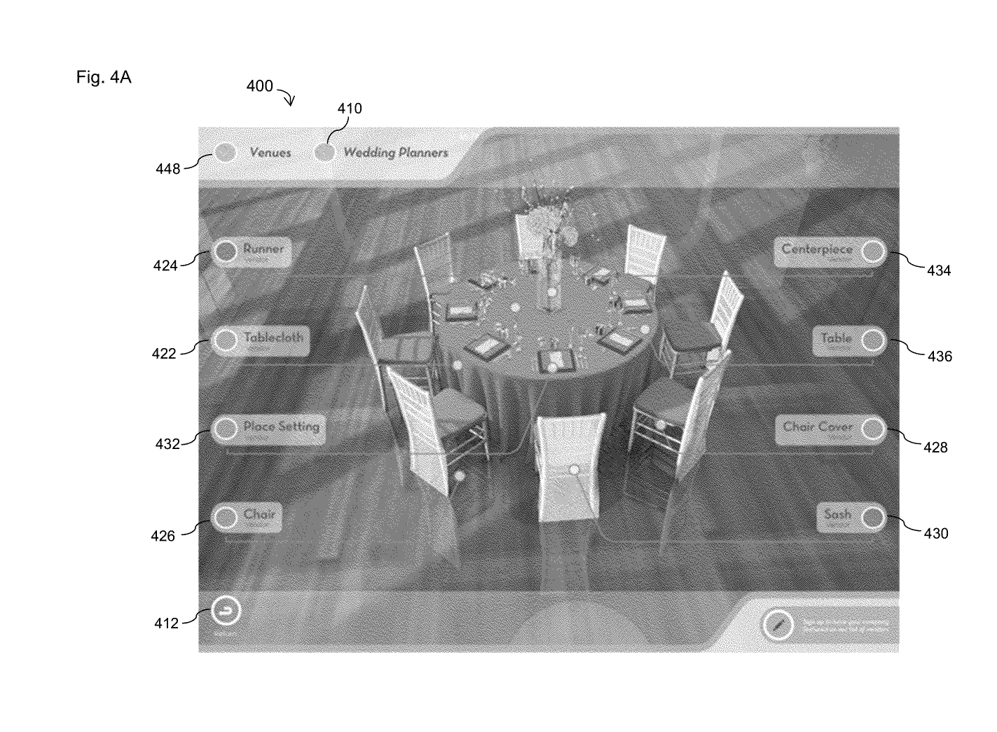

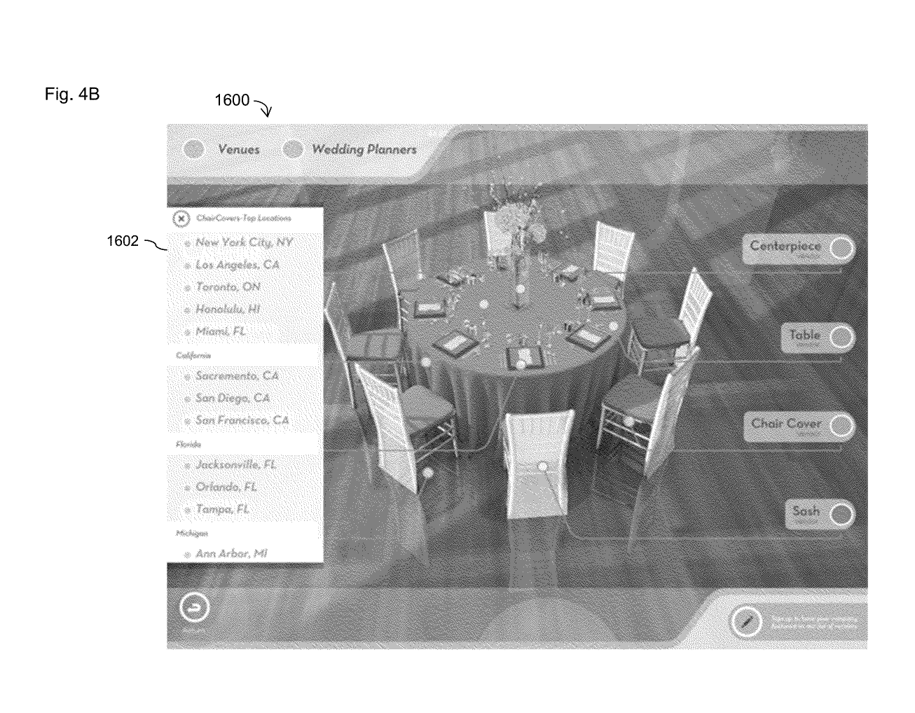

FIG. 3A shows a screenshot of the first focal space view for the event planning system, e.g. such as is shown in the start arrangement block 218. In a preferred embodiment as shown in FIG. 3A, the focal space is a reception room 300. In this illustrated embodiment, reception room 300 contains a plurality of selectable user parameters. The reception room 300 shows selectable user parameters across the bottom, on the left side, and on the right side of the user display. In FIG. 3A, the first focal space has the first, second, and third menus. The first menu is disposed on the left side (e.g. user parameters 372-380), the second menu is disposed on the right side (e.g. user parameters 370), and the third menu is disposed on the bottom (e.g. user parameters 352-344). The first, second, and third menus outline the first focal space or minimum room 300.

The system can receive at least one user entry from the bottom row or third menu. Across the bottom, the user can select user parameters 320-334. These are floor plan 320, tablecloth 322, runner 324, chair 326, chair covers 328, sashes 330, place settings 332, and center pieces 334. Once a user selects a user parameter, it becomes a selected user parameter. Other user parameters may remain unselected. Upon selecting a user parameter, the system populates the visual display of the focal space with the selection, in this case, the reception room 300. In a preferred embodiment as shown in FIG. 3A, the left side of reception room 300 will populate with a plurality of selectable user parameters.

In this embodiment, one user entry from the row may update the first column and the second column. For example, once the user selects chair covers 328, the left side of reception room 300 populates with chair 372 through chair 380. The user can select which chair to display in the reception room 300. The right side of reception room 300 populates with a variety of colors 370. Each color is a selectable user parameter. Additionally, one user entry from the row may update all of the first column, second column, and row with new user parameters to select.

In one aspect, the third menu may be a genus of selectable user parameters, the first menu may be a species of selectable user parameters, and the second menu may be a subspecies of selectable user parameters wherein the computer system receives the at least one user entry from the genus of selectable user parameters and, in response, updates the species and subspecies of selectable user parameters, defining a menu hierarchy. The inventors have found this type of hierarchy to be an intuitive user interface that is quickly and easily navigable. As discussed herein, the selection of a genus may change the options displayed within the species and subspecies. Likewise a further selection of species will change the options displayed within the sub-species, all of which is preferably based directly on the vendor data.

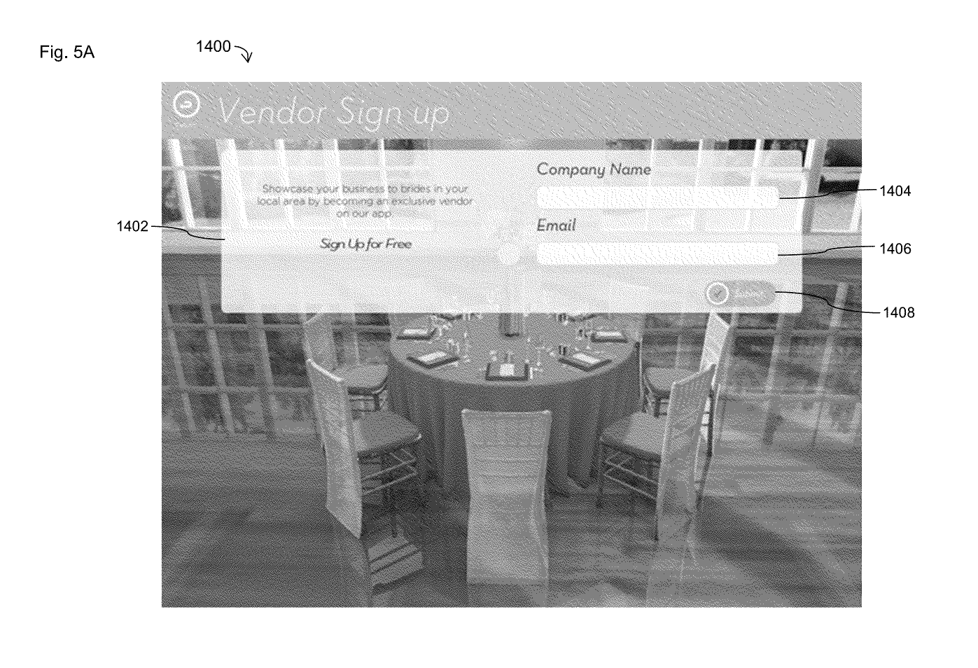

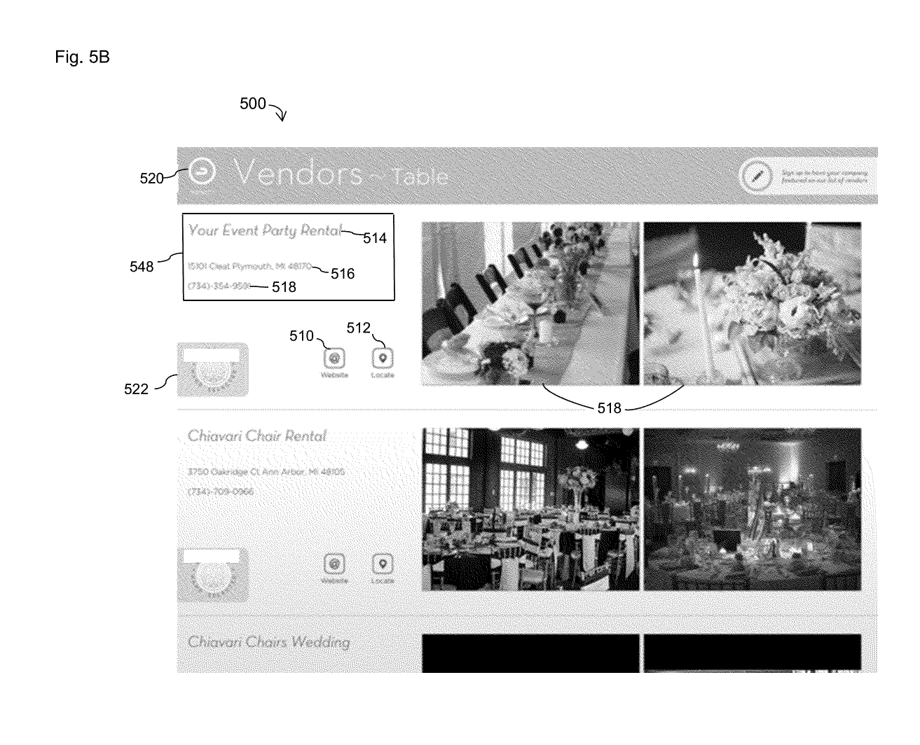

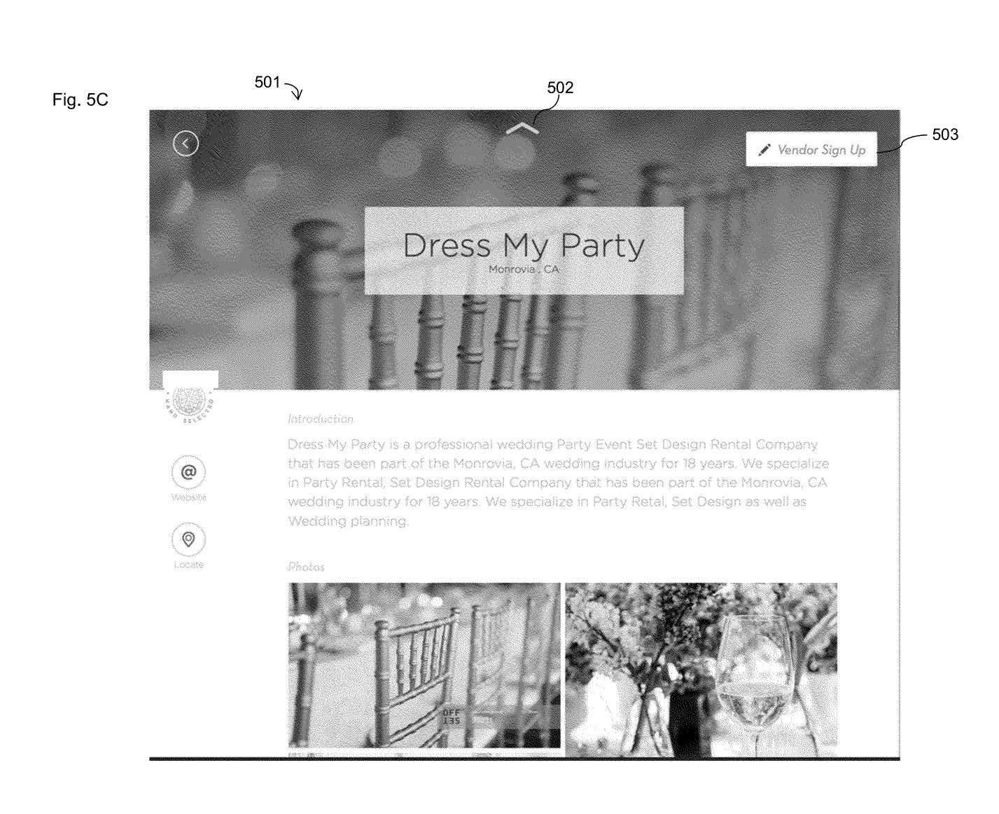

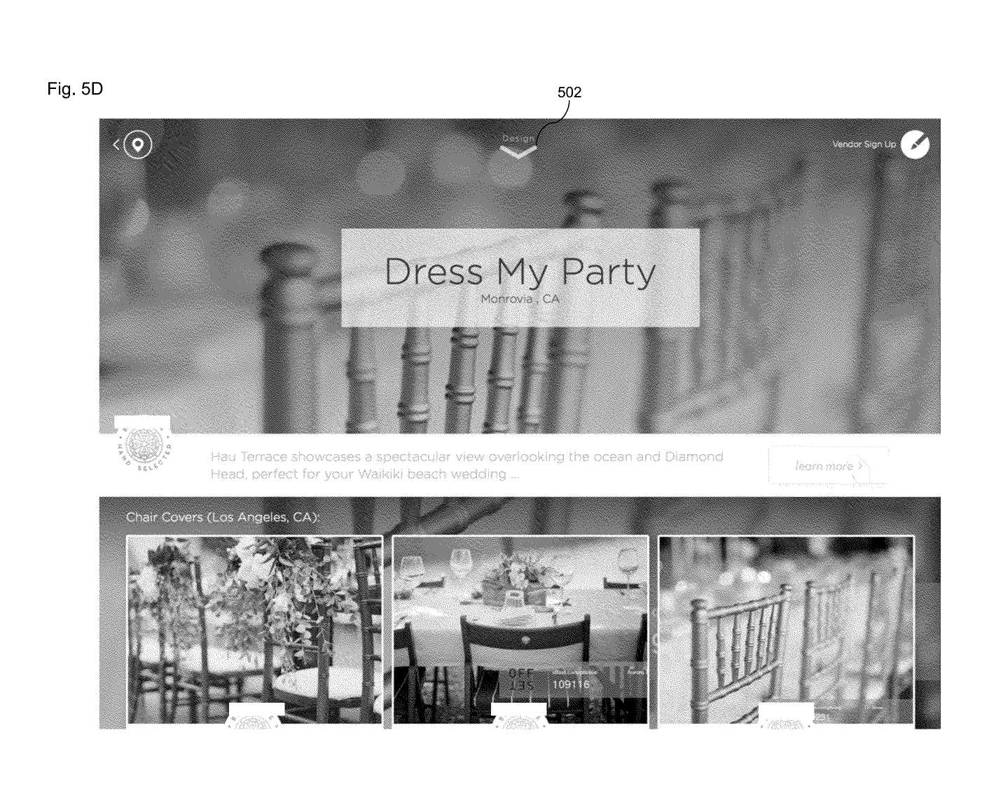

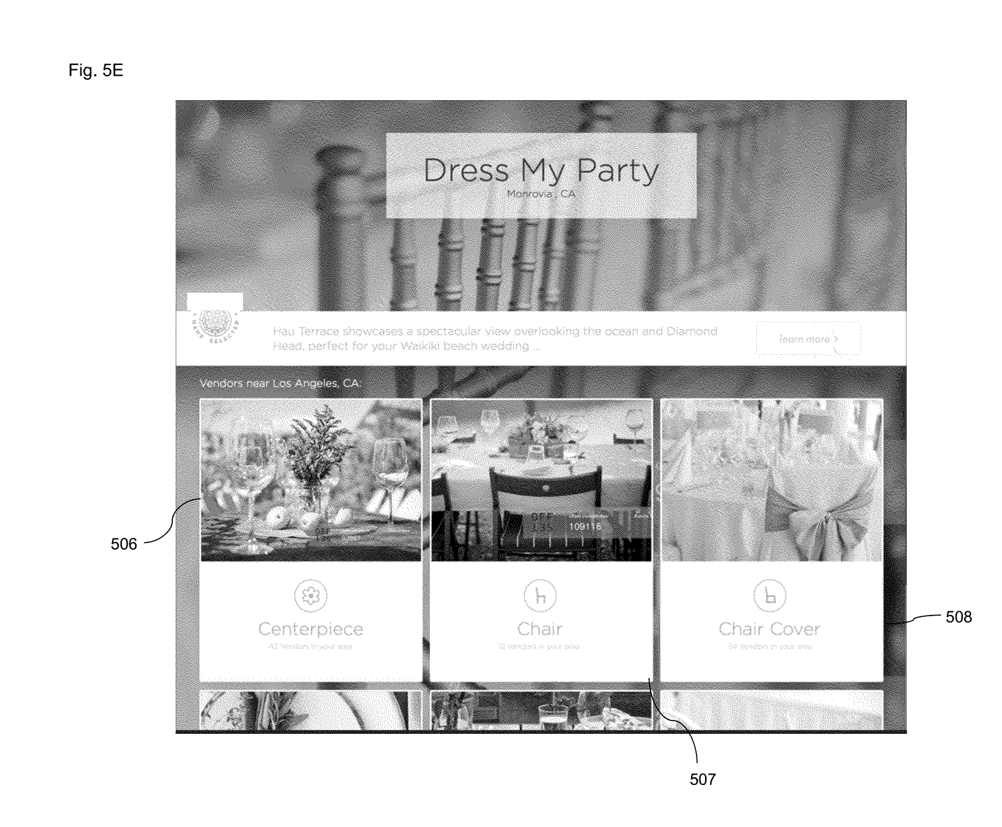

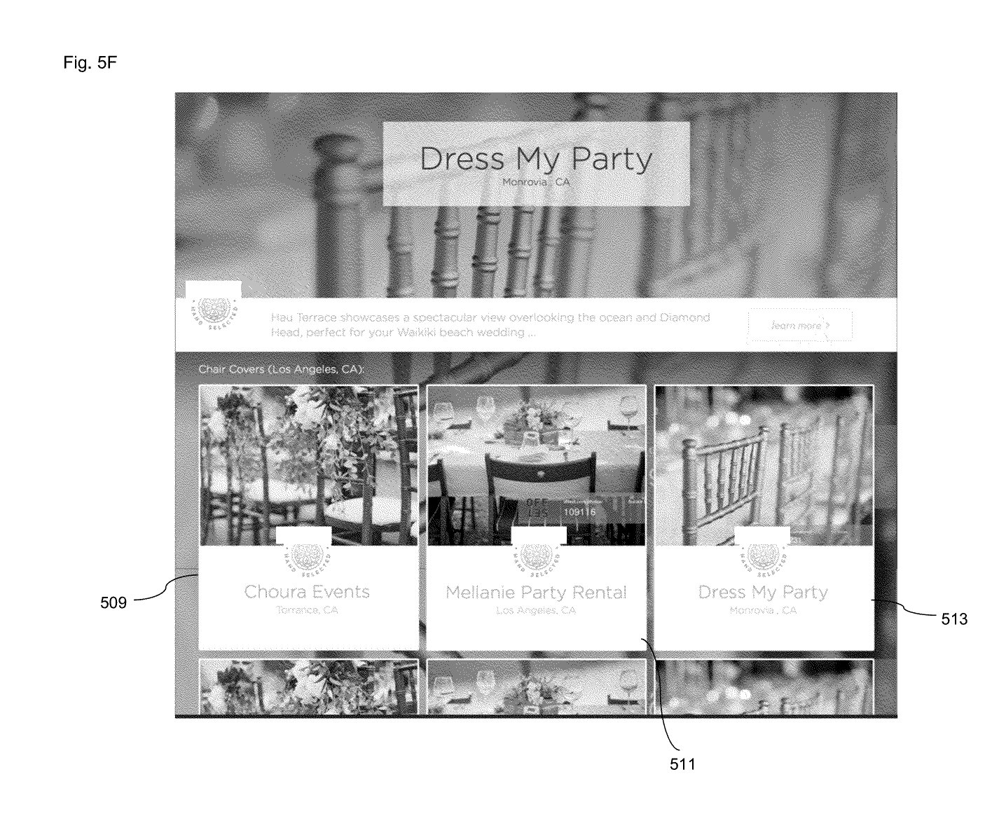

Once the user has selected one or more parameters, the user can tap a vendor button 348. This vendor button 348 populates vendor information in a vendor list. Such functionality is also shown in vendor list block 248, vendor signup block 250, price list block 236, and itemized items block 238 of FIG. 2, and vendor list 500 in FIG. 5B. Buttons may take on other forms, such as a link or icon.

The user can select budget or cost summary 366 and enter budget information. The budget information entered in budget 366 functions two ways. First, the user can enter budget 366 and the system will automatically re-categorize and update selectable user parameters with those that fit the user's entered budget 366. Alternatively, the user can select user parameters before entering a budget 366. Upon selecting user parameters, the system calculates how much the chosen user parameters will cost from appropriate vendors. While interacting with the system, the system may display a cost summary or budget based on the subset of vendor information associated with user entries. The cost summary may be based on one user entry or a plurality of user entries.

FIG. 3B shows one embodiment of the cost summary screen 1500, with cost summary or budget 1566 and vendor list 1548. Upon selecting user parameters, the user selects budget 1566 and an estimated price list 1550 appears. Such estimated price list 1550 shows an individual item 1552, including its name, price, quantity, and total price. The estimated price list 1550 also shows a grand total price, such as a grand total price for table 1554. By zooming out, the user can see a grand total for the entire focal space 1556.

Returning to FIG. 3A, the system offers different options to save a focal space and selected user parameters. The user can select save 368 to save a focal space in the system's memory (e.g. first or second storage). The first focal space may be saved to either the first storage or the second storage (usually being the second storage to conserve space in the first storage). The user can select camera snapshot 342 to save a two-dimensional image of the focal space. The user can also select movie 344 to take a movie of the focal space, using the three-dimensional functionality of the system. Finally, the user can tap the home button 352 to return to select a new focal space (e.g. minimum room 216) or other saved focal spaces.

At any point in the reception room 300, the user can zoom-out or expand the view. Zooming-out allows the user to view more of the reception room 300. In a preferred embodiment, the zoomed-out view will automatically fill with multiple copies of table 386 to fill in a portion of the reception room 300. In a preferred embodiment, table 386 will fill in reception room 300 according to the selected table configuration.

Returning to FIG. 2, the user can navigate from the minimum room 216 to the make reality block 246. Such step allows the user to view the focal space as it has been customized by the user with accompanying vendor information.

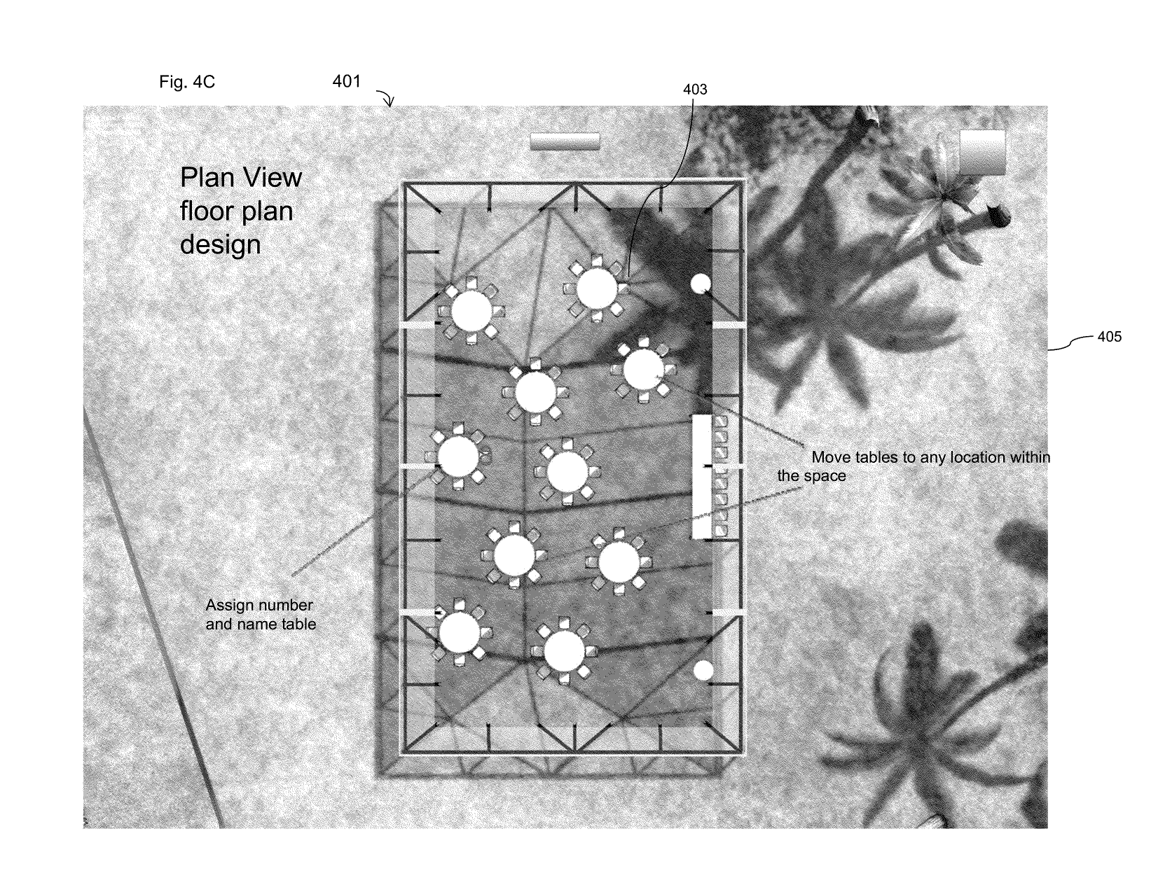

FIG. 4A shows another screenshot of the customized reception room 400. The user can see the selected runner and vendor 424, selected tablecloth and vendor 422, selected place setting and vendor 432, selected chair and vendor 426, selected center piece and vendor 434, selected table and vendor 436, selected chair cover and vendor 428, and selected sash and vendor 430. If multiple vendors provide a particular selected user parameter, the system can provide a list of user parameter locations. As in one embodiment in FIG. 4B with customized reception room 1600, location list 1602 shows locations for chair covers.

Returning to FIG. 4A, if the user wants to return to a previous screen the user can select return button 412. If the user wants to view other venues, the user can select venue 448. Finally, if the user wants to find wedding planners, the user can select wedding planners 410.

FIG. 4C depicts another aspect of the system in which the first focal space 405 may be shown in an overhead view 401 or plan view. The user may select a button on the first display (not shown) to convert the first focal space from a view similar to FIGS. 4A-B to the overhead view 401. In this view, the user may view the overall configuration and select or tap a table (e.g. table 403) to arrange the configuration. The overhead view may prompt the system to switch the first display from a three-dimensional view of the first focal space to a two-dimensional view of the first focal space wherein the two-dimensional view displays the entire first focal space on the first display

As noted above, system users can be the event planner or an event vendor. In one embodiment, all users use the system in the same way. In another embodiment, different users can use the system in a different way. For example, event planners can select user parameters and customize a focal space to plan an event, further using vendor information to locate their selected user parameters and make their event a reality. In this embodiment, vendors will provide vendor information to aid in event planning.

In order to do this, the system will prompt vendors to enter vendor information as a plurality of vendor inputs, such as venue, real-time price list, real-time availability, products, colors, pictures, name, address, email, phone number, website, and advertising, at a vendor sign up screen. Such vendor sign up screen 1400 is shown in FIG. 5A. Here, a vendor can sign up by selecting the Sign Up for Free button 1402. In one embodiment, the vendor enters its company name 1404, email 1406, and selects the submit button 1408. A skilled artisan will understand that any such information may be received, stored, and updated by a vendor. Such information will be received, stored, accessed, categorized, and re-categorized as necessary to provide selectable user parameters. In one embodiment, vendors can be any product or service provider. In another embodiment, vendors can be wedding planners.

Vendors may pay for premier placement on the first focal space or focal space. In this way, the vendors may use the system as a marketing platform. Further, the system may have a vendor rating feature where industry experts and users may rate and rank vendors.

Some vendor inputs may comprise a minimum room or event space. In this case, each vendor input may be modeled from scratch on-site to add to the three-dimensional first focal space. This aids in interactive, accurate, and real-time event planning, especially at a remote location.

FIG. 5B shows a vendor list 500. The system may display a vendor list based on a subset of the vendor information. Vendor list 500 displays pricing, preferably containing real-time data, on vendor products. A skilled artisan will understand the utility of real-time pricing and availability for vendor products. The real-time feature allows users to see updated pricing and pictures of available products. It also allows user to place those products in their customized focal space, and navigate around that customized focal space. This facilitates real-time, cost-conscious, remote, accurate event planning.

In one embodiment, vendor information may be stored within the system. Vendor information can be stored in the first or second storage. In this embodiment, vendors provide specific information that is necessary to populate a vendor list. A skilled artisan will understand that any type of vendor information can be stored to populate or create any desired user parameter. As new selectable user parameters are created for this system, new vendor information can be received and stored, updating the vendor information. The vendor information storage may be akin to a web browser, where the user uses the system to search for vendor information to assist in planning.

Alternatively, vendor information may be stored on a remote server and accessed by this system. With either type of vendor information storage, such information can be categorized and re-categorized as necessary to populate selectable user parameters, lists, themes and the like. Storage of vendor information will be discussed in greater detail below with FIG. 10.

Once the vendor list 500 populates, it will show vendor contact information 548. The user can see any information the vendor has entered, such as the vendor name 514, vendor address 516, vendor phone number 518, vendor website 510, and vendor directions in vender locate 512. The user can also see vendor product information, such as product pictures 518. Vendor rating 522 also provides for the vendor rating system.

From this vendor list 500, the user can select website 510 and be taken outside of the system to the vendor's website. Preferably the system includes an internet browser, or calls to an existing web browser on the computer system. They can also use vendor locate button 512 to map the address of a particular vendor. Upon viewing vendor information, the user can select return button 520 and be taken from the vendor list back to the previous screen.

FIGS. 5C-F show additional aspects of the vendor information. In FIG. 5C, the user may view vendor screen 501, using arrow 502 that populates based on vendor input (e.g. added by way of the Vendor Sign Up 1400 or 503). In FIG. 5E, vendor information may give available centerpieces 506, chairs 507, or chair covers 508. In FIG. 5F, vendor information may also be related vendors 509, 511, 513.

Returning to FIG. 2, to start a new project, the user can use home button block 252 to select a new first focal space, creating a plurality of first focal spaces. Users can do this by selecting a featured venue block 258 or a theme venue block 260. Upon selecting either a feature venue block 258 or a theme venue block 260, users will be taken to a new minimum room 216. They can go through the steps of customizing that focal space by using color theme picker block 262 and edit mode venue block 264. Additionally, they can upgrade the event planning system with upgrade block 267.

In a preferred embodiment, when the user selects theme venue block 260 for a minimum room 216, the system updates selectable user parameters to correspond to the chosen theme. For example, selecting a theme will update and re-categorize selectable user parameters such as color and venue. Once the user selects a theme and a minimum room 216, that minimum room will automatically be updated to a customized minimum room corresponding to the chosen theme. Users can select themes, such as vintage, classic, tropical, minimalist and the like. Upon selecting a theme, the system displays selectable user parameters that fit with that theme. The system also displays vendor information that fits with the chosen theme.

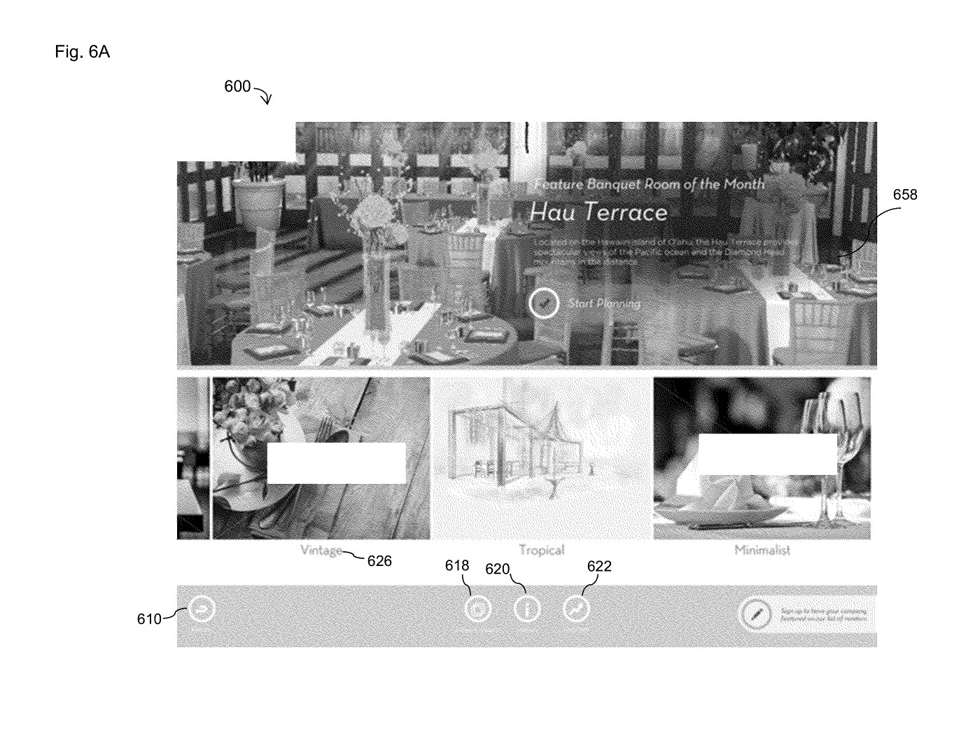

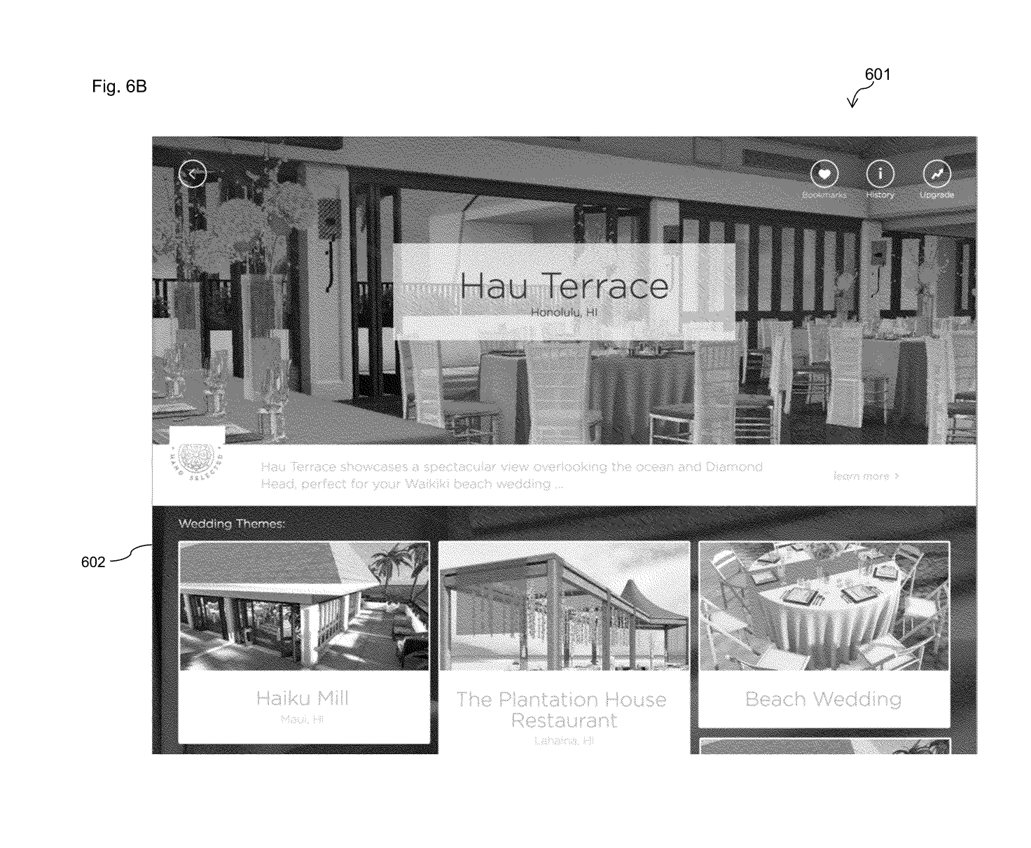

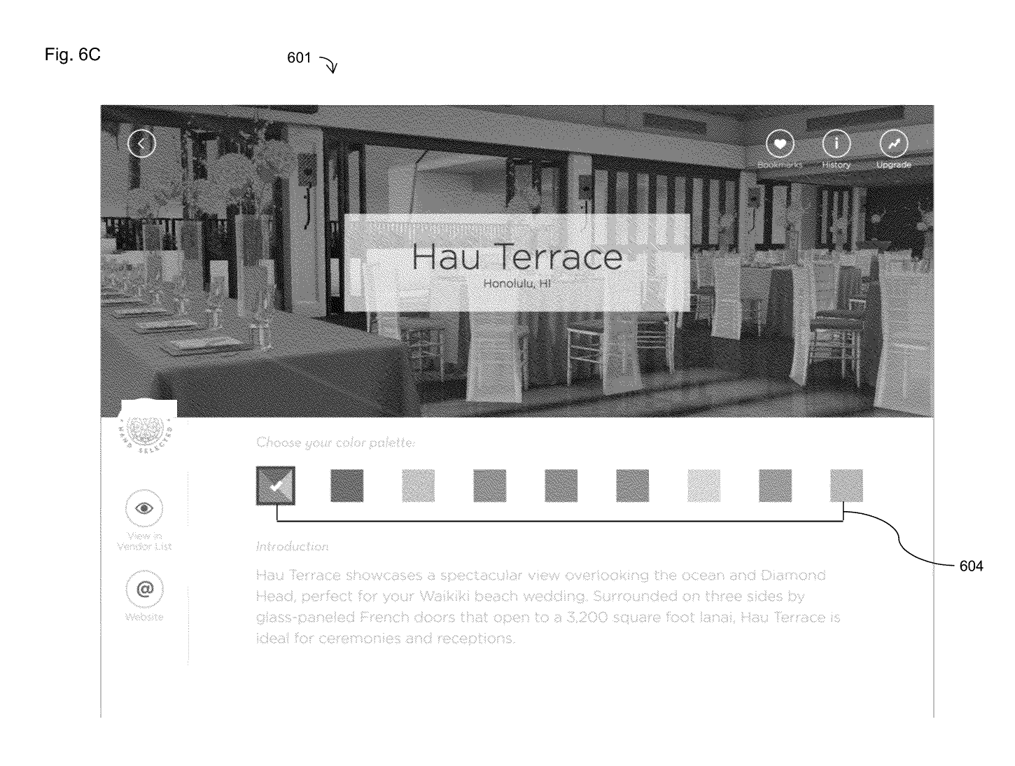

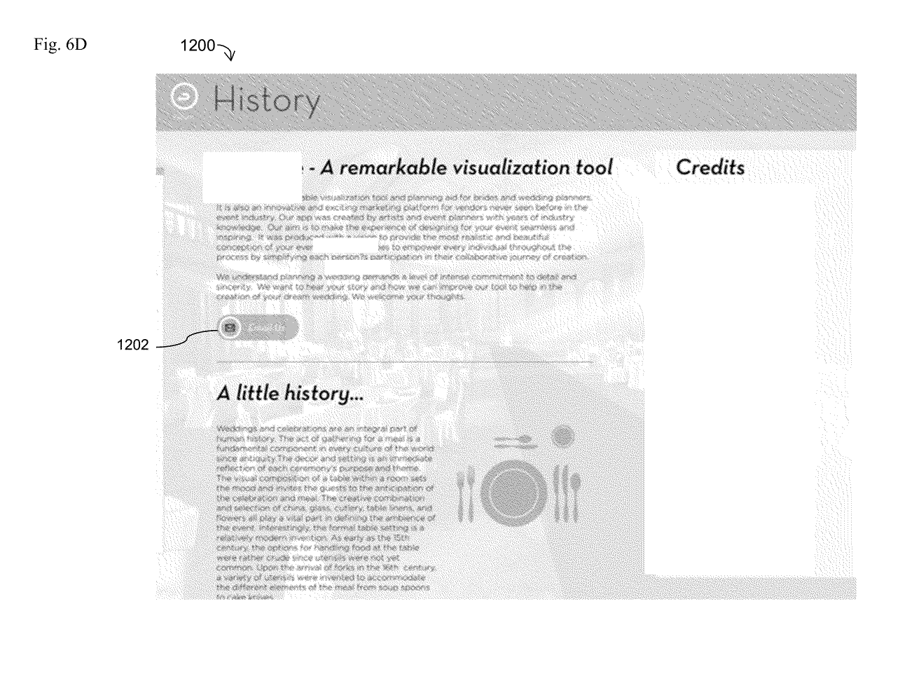

FIG. 6A shows a screenshot illustrating a preferred embodiment of a featured venue in accordance with the event planning system. In FIG. 6A, featured venue 600 shows the Hau Terrace as the Featured Banquet Room of the Month 658. For this featured venue, the user can select a theme 626 that limits selectable user parameters to those corresponding to the chosen theme, as discussed above. From featured venue 600, the users can return to a project gallery 618, view a history 620 of the event planning system, or return to the previous screen using return 610. The user can also upgrade 622.

Upon selecting history 620, the user is taken to history screen 1200, shown in FIG. 6D. History screen 1200 describes the utility of the event planning system. This history screen 1200 allows the user to email the creators for further input on the system at the email us button 1202.

FIG. 6B shows an alternative configuration 601 for the featured banquet room or other featured vendor. Themes 602 for the featured banquet room may also be displayed. In FIG. 6C, a user may select a color palette 604 for the featured banquet room. Such color palette may update vendor information for the featured vendor.

In an embodiment of the present invention, the system has locked and unlocked parts or selectable user parameters. The system allows the user free access to some system features, as shown in FIG. 2, box 268. However, in order to access selectable user parameters in free download user restriction box 266, the user must pay for a system upgrade. By upgrading, as seen in upgrade 622 (FIG. 6A), more or all system features are available to the user. In a preferred embodiment of the present invention, the system features accessible for free are a variety of minimum rooms 216. However, if users wish to customize a minimum room 216 with a configuration, products, colors, and other selectable user parameters, they must upgrade their system.

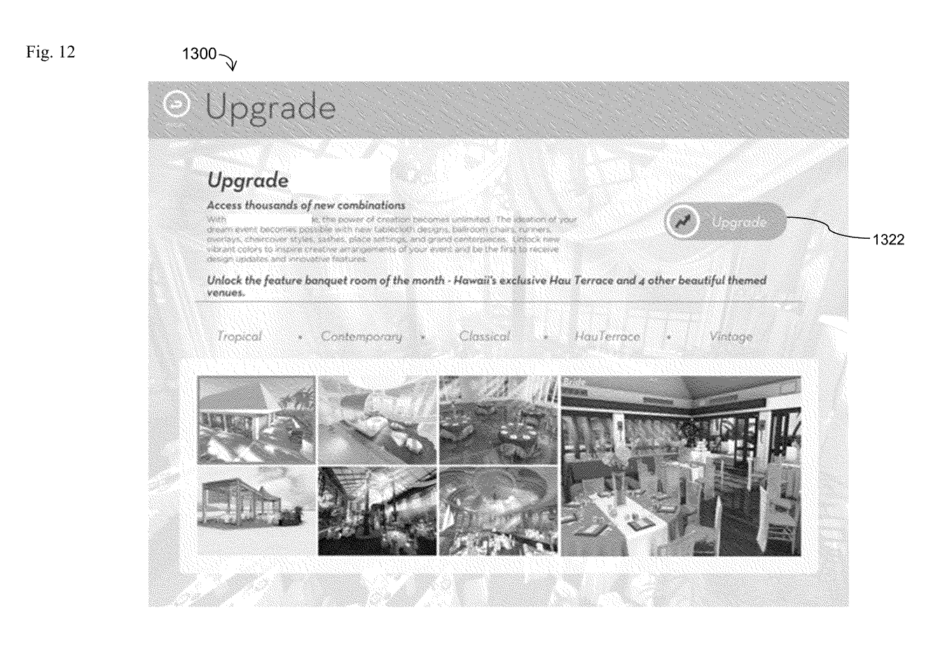

For example, FIG. 12 shows an upgrade screen 1300. By selecting upgrade button 1322, the user will unlock access to restricted selectable user parameters. In one embodiment, an upgrade unlocks access to the Feature Banquet Room.

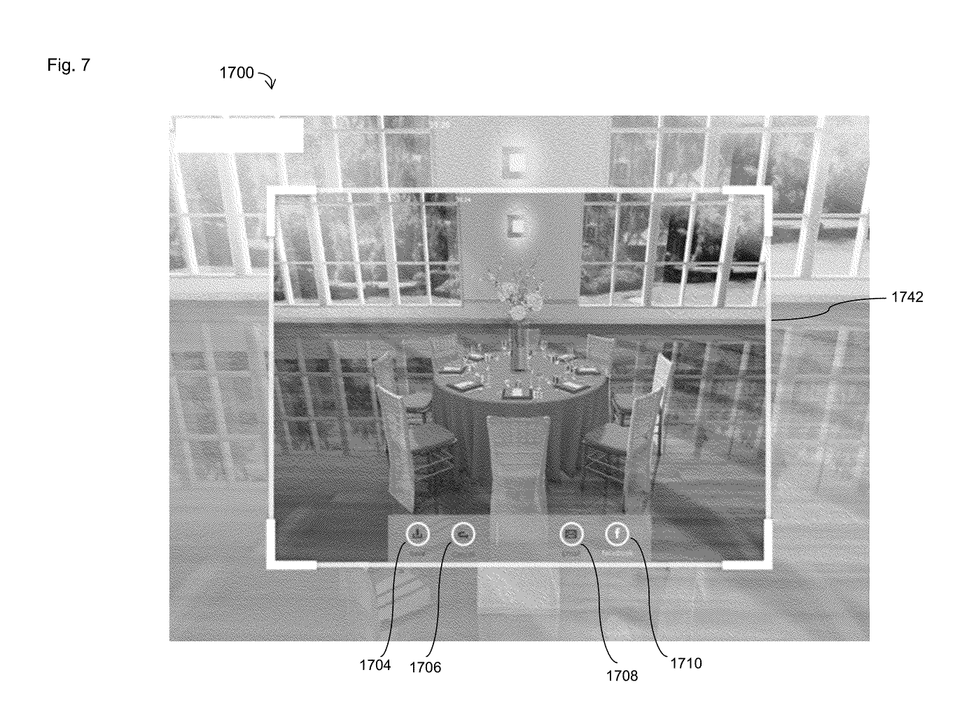

FIG. 7 shows a screenshot of a snapshot view 1700. Such snapshot view 1700 shows snapshot frame 1742, surrounding the focal space or part of the focal space. In one embodiment, the user takes a snapshot of a customized table. The user can also save the snapshot using save button 1704, cancel the snapshot using cancel button 1706, email the snapshot using email button 1708, and post the snapshot to a website using social media button 1710. A skilled artisan will understand that such websites accessible through social media button 1710 are Facebook, Twitter, Pintrest, Snapchat, Instagram, and the like.

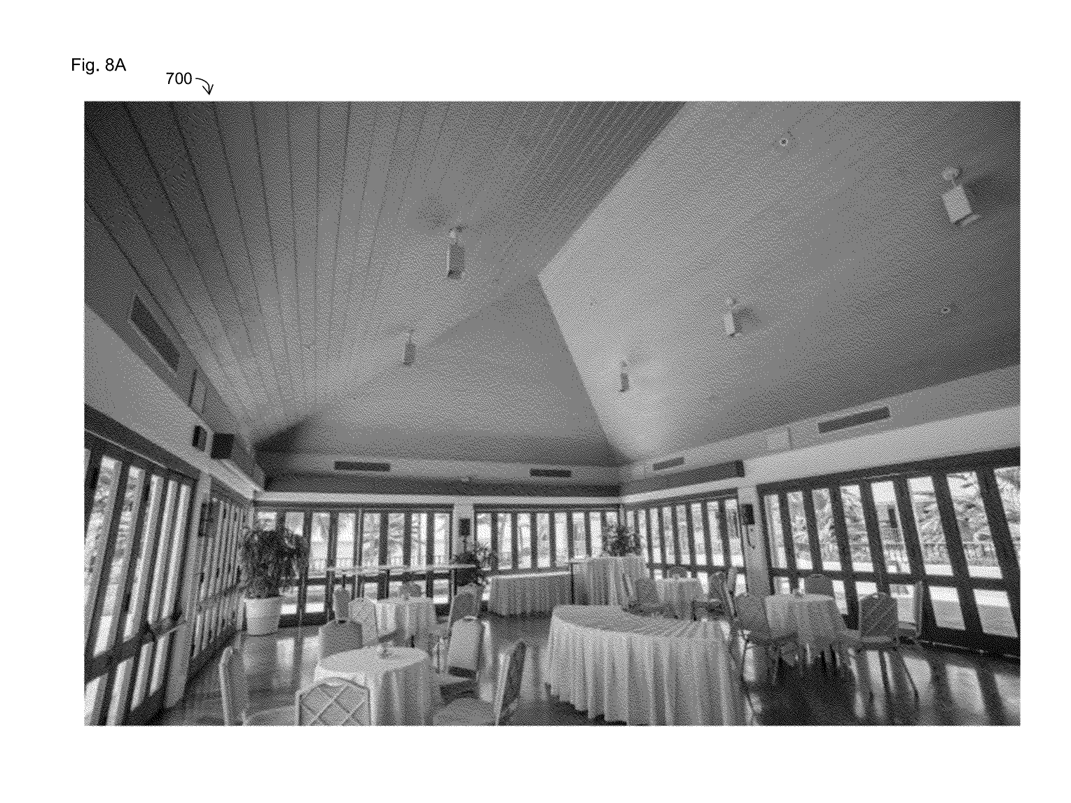

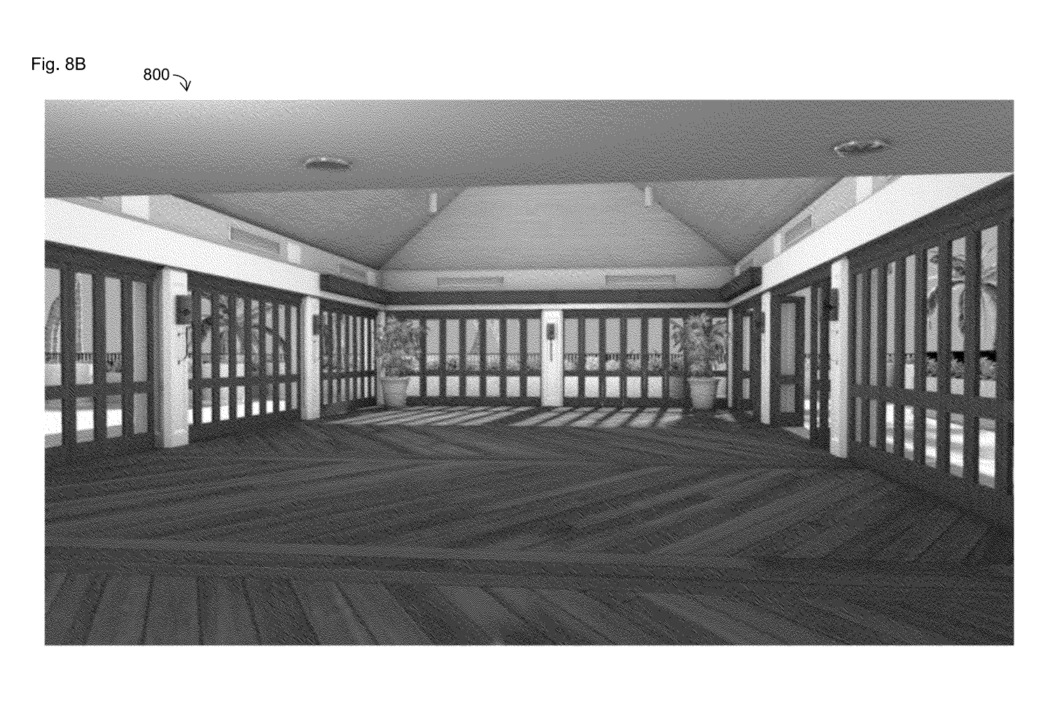

FIGS. 8 through 9 show screenshots illustrating different views of a movie block 244 in accordance with the event planning system. Views 700-800 show first views of a movie. View 900 shows a second view of a movie of a focal space using the event planning system. It should be understood that these views may also be snapshots using the camera snapshot block 242.

Not only can the user make movies and snapshots to post on website, but the user can share all information in the first focal space with other users at remote locations. For example, an additional user may have a third processor including a third display wherein the third processor accesses the saved first focal space comprising the first selected user parameters from the user storage, the third processor displays the first selected user parameter on the third display. The third processor may be adapted to receive further user entry (e.g. another user), defining third selected user parameters, the third processor saves the third selected user parameters in the user storage.

Any additional system users may be able to access any user storage from the third processor. Further, user storage may be tracked and logged. Any selected user parameters and frequency of use may be tracked by the system, saved in user storage, and accessible to vendors. User storage may be utilized to provide users with the selectable user parameters that they may find helpful, including recommendations to vendors, current trends, and styles, products, and the like.

A preferred embodiment of this event planning system combines hardware and software. The system may comprise a first device, a second device, and a third device. FIG. 10 shows an exemplary computer system for use with the event planning system. Any of the features described here can be implemented on one or more devices. The computer system 1000 includes a processor 1002 for executing instructions such as those described in the methods above. The instructions may be stored on a computer readable medium such as in memory 1004 or storage devices, such as storage 1010. The instructions include those for three-dimensional functionality of the focal spaces. Suitable storage devices can include a CD, a DVD, a removable disk, or a removable drive. The computer system 1000 may include a display controller 1006 responsive to instructions generated to create a textual or graphical display on the display device 1008. Processor 1002 with memory 1004 may be a second device with a second storage. The second storage may store the user storage and the vendor information.

The computer programming code for carrying out the operations of the event planning system may be written in any combination of one or more programming languages, including an object oriented programming language such as Java, Smalltalk, C++, C# or the like. These programming languages can be written to operate on a variety of platforms such as an AIX Environment or other operating systems such as Windows 7, Linux, iOS, or Android. A preferred embodiment of the present invention is to operate on Apple's Operating System (iOS®).

In addition, the processor 1002 may communicate with a network controller 1012 to communicate data or instructions to other devices. The network controller 1012 may communication over the internet 1014 or other known protocols to distribute processing or provide remote access to information over a variety of network topologies including an Ethernet, Local Area Networks, Wide Area Networks, and other commonly used network topologies. Such network topologies can also allow the event planning system to access information in further remote storage 1018, as necessary. Such further remote storage can be cloud storage.

In one embodiment, the programming code may be executed entirely on one device as a standalone software package, using computer system parts 1002-1010. In another embodiment, the programming code can also be accessed on a remote device or entirely on a remote server. The remote device, such as device 1016, may be connected using the network controller 1012 as described previously. The remote device 1016 could take user entries or inputs 1020 from the user and give outputs 1022.

Device 1016 may be the first device with the first display for displaying the first focal space and the first set of selectable user parameters. The first device 1016 may receive user entry 1020 indicative of the user selecting from the first set of selectable user parameters, defining the first selected user parameter. The second device may be adapted to retrieve the subset of the vendor information corresponding to the first selected user parameter and send the subset to the first device 1016 wherein the first device 1016 updates the first display with the subset of the vendor information.

The first device 1016 could have limited storage ability compared to the second storage or memory 1004. In one embodiment, the event planning system may store information for five to six focal spaces or minimum rooms on the user's remote device 1016. In this embodiment, the event planning system accesses programming code and information for additional focal spaces saved in storage through a network topology, such as the internet 1014. Such storage could be any or all of storage 1010, memory 1004, and further remote storage 1018. In this embodiment, the user's remote device 1016 acts as a shell to receive additional information stored elsewhere.

In one embodiment, the event planning system updates vendor information on the user's remote device 1016 through a network topology, such as the internet 1014. Such vendor information updates could be stored, updated, and accessed at any time in any or all of storage 1010, memory 1004, and further remote storage 1018. To update, the event planning system receives, stores, accesses, categorizes, and re-categorizes the vendor information. This allows the system to provide real-time data, as discussed above. A skilled artisan will understand how multiple users, both event planners and vendors, can connect, use, and update the event planning system over the computer system described in FIG. 10.

Additionally, the system could have a third device (not shown) similar to the first device 1016 designed for user entries. When the user saves the first focal space, the user or a different user could access the saved first focal space on the third device. The third device may include a third display wherein the third device accesses the saved first focal space comprising the first selected user parameters from the user storage, the third device displays the first selected user parameter on the third display.

The third device could also customize and save the first focal space. In one embodiment, the third device is adapted to receive a second user entry on the third display, the second user entry defining a third selected user parameter, the second device being adapted to save the third selected user parameter in the user storage.

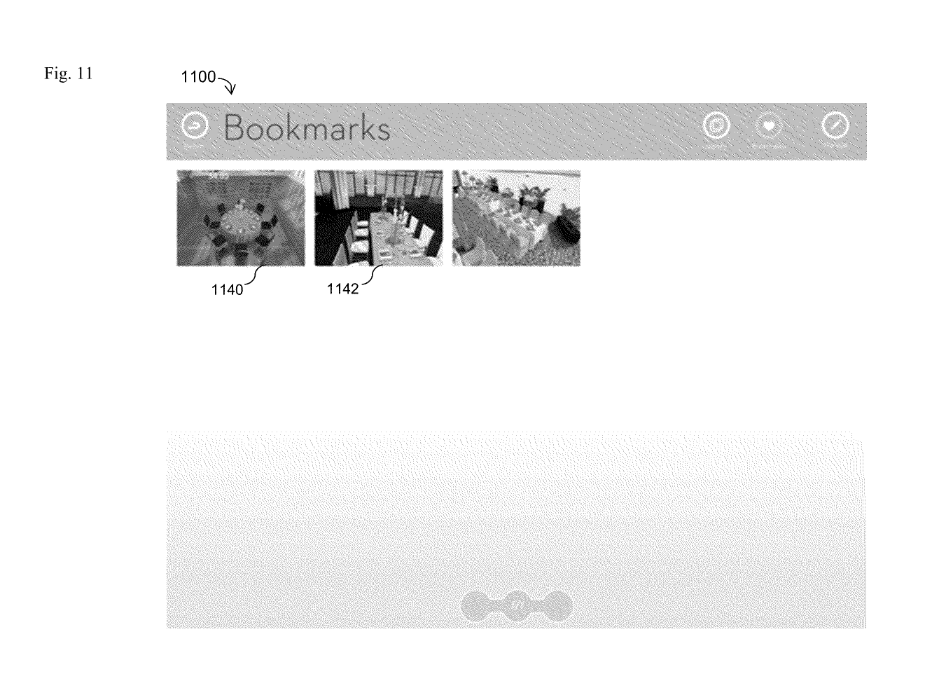

Returning to FIG. 2, the system has instructions to use bookmark block 240, which allows users to save a customized focal space. FIG. 11 further shows bookmark gallery 1100. In bookmark gallery 1110, the user can see a list of bookmarked focal spaces 1140 and 1142. The user can select a bookmarked space 1140 to view a customized room. Returning to FIG. 2, the user can also see the bookmark gallery 1100 through project gallery block 256.

It should be understood that the foregoing relates to exemplary embodiments of the disclosure and that modifications may be made without departing from the spirit and scope of the disclosure as set forth in the following claims. While the disclosure has been described with respect to certain embodiments it will be appreciated that modifications and changes may be made by those skilled in the art without departing from the spirit of the disclosure.

1. An article of manufacture comprising a first device and a machine-accessible medium, the machine-accessible medium having instructions encoded thereon for enabling a user to use a machine to perform operations of:
displaying a first focal space on the first device, the first device having a first storage and a first display, the first display displaying the first focal space, the first focal space being three-dimensional and customizable, the first focal space including a first set of selectable user parameters;
receiving at least one user entry indicative of the user selecting from the first set of selectable user parameters, the at least one user entry defining a first selected user parameter;
communicating with a second device having a second storage, the second storage comprising a user storage for saving the first focal space and a vendor information storage containing vendor information, the second storage being remotely stored from the first storage;
retrieving a subset of the vendor information corresponding to the first selected user parameter; and
updating the first focal space on the first display with the subset of the vendor information corresponding to the first selected user parameter, whereby the article of manufacture assists in event planning.

2. The operations of claim 1 wherein the step of displaying a first focal space comprises the first focal space being a plurality of first focal spaces for event planning.

3. The operations of claim 1 wherein the step of communicating with a second device comprises updating the vendor information with a plurality of vendor inputs, the plurality of vendor inputs being real-time.

4. The operations of claim 1 wherein the step of communicating with a second device comprises the vendor information being selected from a group of a minimum room, a cost, availability, a product, a color, a name, an address, a phone number, a website, and advertising.

5. The operations of claim 1 wherein the step of receiving at least one user entry comprises the first selected user parameter being selected from a group of a minimum room, a theme, a product, a color, and a date.

6. The operations of claim 1 wherein the step of receiving at least one user entry comprises the first display being a touchscreen having a plurality of first buttons, the first selected user parameter being received by way of one of the plurality of first button.

7. The operations of claim 1 further comprising interacting with the first focal space after the step of updating the first focal space, wherein interacting with the first focal space comprises a step selected from a group of expanding the first focal space, reducing the first focal space, displaying a short movie of the first focal space, displaying a snapshot of the first focal space, and displaying an overhead view of the first focal space.

8. The operations of claim 7 wherein the step of displaying an overhead view comprises the first display switching from a three-dimensional view of the first focal space to a two-dimensional view of the first focal space wherein the two-dimensional view displays the entire first focal space on the first display.

9. The operations of claim 1 further comprising displaying a vendor list based on the subset of the vendor information after the step of updating the first focal space.

10. The operations of claim 1 further comprising displaying a cost summary based on the subset of the vendor information after the step of updating the first focal space.

11. The operations of claim 10 wherein the step of displaying a cost summary comprises receiving a plurality of user entries indicative of the user selecting from the first set of selectable user parameters wherein the cost summary is based on the plurality of user entries.

12. A method of using a graphical user interface by a user, the graphical user interface being a component in a computer system, the computer system having a display and a user interface selection device, the method comprising:
providing a first focal space comprising a first, a second, and a third menu, the first focal space being displayed on the display, the first menu being a first column of selectable user parameters, the second menu being a second column of selectable user parameters, and the third menu being a row of selectable user parameters, the first, second and third menus defining a plurality of possible user entries;
receiving at least one user entry indicative of the user interface selection device selecting one user parameter of one of the first column, second column, and row of selectable user parameters; and
in response to the at least one user entry, updating the other two of the first column, second column, and row to display a plurality of user parameters associated with the at least one user entry, whereby the graphical user interface assists in event planning.

13. The method of claim 12 wherein the step of providing a first focal space comprising the display having a left side, a right side, and a bottom, the first menu being disposed on the left side, the second menu being disposed on the right side, and the third menu being disposed on the bottom wherein the first, second, and third menus outline the first focal space.

14. The method of claim 12 wherein the step of receiving at least one user entry comprises receiving the at least one user entry from the row of selectable user parameters.

15. The method of claim 14 wherein the step of updating the other two of the first column, second column, and row comprises updating the first and second columns of selectable user parameters.

16. The method of claim 15 wherein the step of updating the other two of the first column, second column, and row comprises updating all of the first column, second column, and row.

17. The method of claim 12 wherein the step of updating the other two of the first column, second column, and row comprises the third menu being a genus of selectable user parameters, the first menu being a species of selectable user parameters, and the second menu being a subspecies of selectable user parameters wherein the computer system receives the at least one user entry from the genus of selectable user parameters and, in response, updates the species and subspecies of selectable user parameters, defining a menu hierarchy.

18. A system for event planning by a user, the system comprising:
a first device with a first storage and a first display, the first display displaying a first focal space, the first focal space being three-dimensional and customizable, the first focal space including a first set of selectable user parameters, the first device being adapted to receive a first user entry indicative of the user selecting from the first set of selectable user parameters, the first user entry defining a first selected user parameter; and
a second device having a second storage, the second storage comprising a user storage for saving the first focal space and a vendor information storage containing vendor information, the second storage being remotely stored from the first storage, the second device being adapted to retrieve a subset of the vendor information corresponding to the first selected user parameter, the second device being adapted to send the subset of the vendor information to the first device wherein the first device updates the first display with the subset of the vendor information, whereby the system assists in event planning.

19. The system of claim 18 further comprising a third device including a third display wherein the third device accesses the saved first focal space comprising the first selected user parameters from the user storage, the third device displays the first selected user parameter on the third display.

20. The system of claim 19 wherein the third device is adapted to receive a second user entry on the third display, the second user entry defining a third selected user parameter, the second device being adapted to save the third selected user parameter in the user storage.
